(19) United States
(12) Patent Application Publication
(10) Pub. No.: US 2023/0115830 A1
(43) Pub. Date: Apr. 13, 2023

(54) ELECTRICAL POWER GENERATION SYSTEM WITH BATTERY TEMPERATURE REGULATION

(71) Applicant: THRU TUBING SOLUTIONS, INC., NEWCASTLE, OK (US)

(72) Inventors: Andrew M. FERGUSON, Moore, OK (US); Dustin LOCKLEAR, Moore, OK (US); Roger L. SCHULTZ, Newcastle, OK (US)

(21) Appl. No.: 17/938,370

(22) Filed: Oct. 6, 2022

Related U.S. Application Data
(60) Provisional application No. 63/254,670, filed on Oct. 12, 2021.

(51) Int. Cl. H02J 7/00; H02J 3/38; H01M 10/44; H01M 10/613; H01M 10/627; H01M 10/6569; H01M 10/63; H01M 10/48

(52) U.S. Cl. CPC H02J 7/00309; H02J 3/381; H02J 7/0047; H01M 10/44; H01M 10/613; H01M 10/627; H01M 10/6569; H01M 10/63; H01M 10/486; H02J 2300/24; H02J 2300/28; H01M 2220/10

(57) ABSTRACT

An electrical power generation system for use with an electrical power generator can include a battery bank adapted to be charged by electrical power generated by the electrical power generator, and a nitrogen extraction system adapted to be powered by the electrical power generated by the electrical power generator. An electrical power generation method for use with an electrical power generator can include storing electrical power generated by the electrical power generator in a battery bank located at a battery bank site, extracting nitrogen at the battery bank site, and liquifying the nitrogen at the battery bank site.

### CROSS-REFERENCE TO RELATED APPLICATION

This application claims the benefit of the filing date of U.S. provisional application No. 63/254,670 filed on 12 Oct. 2021. The entire disclosure of this prior application is incorporated herein by this reference.

### BACKGROUND

This disclosure relates generally to electrical power generation and storage and, in an example described below, more particularly provides for battery temperature regulation for an electrical power generation system.

Certain types of electrical power generators produce electrical power intermittently, or at least inconsistently. For example, a windmill generator only produces electrical power if wind speed is above a certain level, and a solar cell generator only produces electrical power during daylight hours.

Therefore, it will be appreciated that advancements are continually needed in the art of electrical power generation and storage. The present specification provides such advancements, which may be used with electrical power generators of various types (such as, wind-powered, solar-powered, hydroelectric, etc.).

### BRIEF DESCRIPTION OF THE DRAWING

FIG. 1 is a representative partially cross-sectional view of an example of an electrical power generation system and associated method which can embody principles of this disclosure.

### DETAILED DESCRIPTION

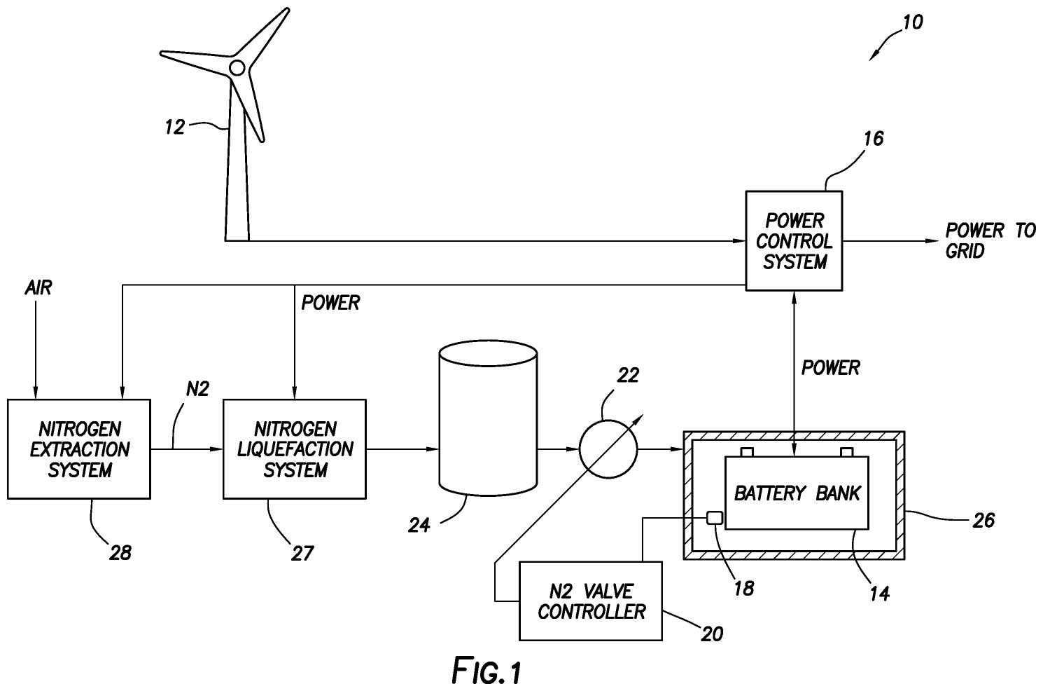

Representatively illustrated in FIG. 1 is an electrical power generation system 10 and associated method which can embody principles of this disclosure. However, it should be clearly understood that the system 10 and method are merely one example of an application of the principles of this disclosure in practice, and a wide variety of other examples are possible. Therefore, the scope of this disclosure is not limited at all to the details of the system 10 and method described herein and/or depicted in the drawings.

In the FIG. 1 example, electrical power is generated by a windmill 12. Other types of electrical power generators may be used with the system 10, such as, solar (photovoltaic) cells, hydroelectric generators, etc. The scope of this disclosure is not limited to any particular type of electrical power generator used with the system 10.

Since the electrical power generated by the windmill 12 can be intermittent, it is desired in this example to store the generated electrical power in a battery bank (comprising one or more batteries) 14. In this manner, the electrical power will be available during periods in which the windmill 12 itself does not produce electrical power (such as, when wind speeds are inadequate to operate the windmill, etc.). During these periods, electrical power can be supplied to the power control system 16 from the battery bank 14.

The use of the battery bank 14 may also, or alternatively, have other purposes (such as, for power conditioning, etc.). The scope of this disclosure is not limited to any particular purpose for use of the battery bank 14 in the system 10.

A power control system 16 is used in the system 10 to direct the electrical power between various components of the system, and to supply the electrical power to a national, state, municipal or local power grid for use by an end user (such as, a residential, industrial or commercial end user). The power control system 16 can comprise components such as electrical switching equipment, programmable logic controllers, processors, volatile and/or static memory, operator input and output devices, and software and/or firmware with instructions for operating the power control system. The scope of this disclosure is not limited to any particular components or configuration of the power control system 16.

In some circumstances, the battery bank 14 could become overheated, such as, in the event that the battery bank is inadvertently overcharged or if the ambient environmental temperature becomes elevated, etc. Some types of batteries can be damaged by overheating. Some types of batteries (such as, lithium ion batteries) can react violently, produce fire or even explode if overheated. Therefore, it is desirable in the system 10 to prevent overheating of the battery bank 14.

The system 10 includes a thermal sensor 18 that is capable of sensing the temperature of the battery bank 14. The sensor 18 may comprise any type of temperature sensing device. In some examples, the sensor 18 could comprise a thermal switch or a thermostat. The scope of this disclosure is not limited to use of any particular type of thermal sensor 18 with the system 10.

The thermal sensor 18 is connected to a nitrogen valve controller 20. The nitrogen valve controller 20 controls operation of a valve 22 that selectively permits and prevents fluid communication between a nitrogen source 24 and a housing 26 containing the battery bank 14. When nitrogen flows through the valve 22 and into the housing 26, the nitrogen expands, it changes phase from liquid to gas, and its temperature rapidly decreases. In this manner, the temperature of the battery bank 14 is reduced.

The valve 22 is initially closed during normal operation of the system 10. The nitrogen valve controller 20 causes the valve 22 to open if the temperature of the battery bank 14 increases to a predetermined level. This predetermined level is preferably less than a temperature at which the battery bank 14 would be damaged (such as, a temperature at which the battery bank would be degraded, produce fire or explode, etc.).

After the valve 22 has been opened to reduce the temperature of the battery bank 14, in some examples the valve 22 may then be closed by the controller 20, so that normal operation of the system 10 can resume. The controller 20 may close the valve 22 when the temperature of the battery bank 14 has decreased to less than another predetermined level. In other examples, the system 10 may not return to normal operation until the control system 16 and/or controller 20 is “reset,” (such as, after a problem that produced the battery bank 14 temperature increase is resolved).

As depicted in FIG. 1, the nitrogen source 24 contains liquid nitrogen produced by a nitrogen liquefaction system 27. The nitrogen source 24 may comprise a cryogenic storage device, such as, a Dewar flask capable of storing liquid nitrogen at elevated pressure and reduced temperature. However, the scope of this disclosure is not limited to use of any particular type of nitrogen source.

In this example, the nitrogen liquefaction system 27 receives the nitrogen from a nitrogen extraction system 28. The nitrogen extraction system 28 extracts the nitrogen from ambient air. The nitrogen may be extracted by various different processes, such as, fractional distillation, mechanical separation, etc. In other examples, the nitrogen may be extracted or produced by other means. For example, ambient air may first be liquified, and the liquid nitrogen may then be distilled or otherwise extracted from the liquid air.

Preferably, the nitrogen is extracted, liquified and stored at a power generation site, or at least near the battery bank 14, in the FIG. 1 system 10. For example, windmills and large solar arrays are typically remotely located, and so it would be impractical to supply liquid nitrogen to the power generation site from a central location a substantial distance from the power generation site.

In the FIG. 1 example, electrical power to operate the nitrogen extraction system 28 and the nitrogen liquefaction system 27 is provided by the windmill 12 (or other electrical power generator) via the power control system 16. The controller 20 can also be supplied with electrical power via the power control system 16.

It may now be fully appreciated that the features of the system 10 described above provide for regulating the temperature of the battery bank 14 using nitrogen extracted and liquified at a location close to the battery bank. The electrical power generated by the windmill 12 (or other electrical power generator) is used both to charge the battery bank 14, and to extract and liquify the nitrogen.

The above disclosure provides to the art an example of an electrical power generation system 10 and method, in which a temperature of a battery bank 14 is regulated using nitrogen extracted and liquified at a location close to the battery bank, such as, at a same site as the location of the battery bank. Electrical power generated by an electrical power generator 12 is used both to charge the battery bank 14, and to extract and liquify nitrogen.

The nitrogen is extracted and liquified at a location proximate the battery bank 14. A valve 22 selectively permits and prevents flow of the liquid nitrogen between a nitrogen source 24 and a housing 26 containing the battery bank 14.

A valve controller 20 selectively operates the valve 22 based on an output of a thermal sensor 18 that senses the temperature of the battery bank 14. The valve controller 20 causes the valve 22 to open when the temperature of the battery bank 14 is greater than a first predetermined level. The valve controller 20 causes the valve 22 to close when the temperature of the battery bank 14 is less than a second predetermined level.

The electrical power generator 12 may comprise a windmill, a solar cell, a renewable electrical power generator, or any other type of electrical power generator that generates electrical power stored locally in the battery bank 14.

In one example, an electrical power generation system 10 for use with an electrical power generator 12 can comprise: a battery bank 14 adapted to be charged by electrical power generated by the electrical power generator 12; and a nitrogen extraction system 28 adapted to be powered by the electrical power generated by the electrical power generator 12. The nitrogen can be extracted at a location proximate the battery bank 14.

The electrical power generation system 10 can include a valve 22 that selectively permits and prevents flow of the nitrogen in liquid form between a nitrogen source 24 and a housing 26 containing the battery bank 14. A valve controller 20 may selectively operate the valve 22 based on an output of a thermal sensor 18 that senses a temperature of the battery bank 14.

The valve controller 20 may cause the valve 22 to open when the temperature of the battery bank 14 is greater than a first predetermined level. The valve controller 20 may cause the valve 22 to close when the temperature of the battery bank 14 is less than a second predetermined level.

The electrical power generator 12 may comprise at least one of a windmill, a solar cell and a renewable electrical power generator. The electrical power generated by the electrical power generator 12 may be stored locally in the battery bank 14.

In one example, an electrical power generation method for use with an electrical power generator 12 can comprise: storing electrical power generated by the electrical power generator in a battery bank 14 located at a battery bank site; extracting nitrogen at the battery bank site; and liquifying the nitrogen at the battery bank site.

The electrical power generation method can include flowing the nitrogen into a housing 26 containing the battery bank 14 in response to a temperature of the battery bank exceeding a first predetermined level. The method can also include ceasing the nitrogen flow into the housing 26 in response to the temperature of the battery bank 14 being less than a second predetermined level.

The flowing step can include opening a valve 22 connected between the housing 26 and a source 24 of the nitrogen in liquid form. Operation of the valve 22 may be controlled by a valve controller 20 connected to a thermal sensor 18 in the housing 26. The valve 22 and the valve controller 20 may be powered by the electrical power generated by the electrical power generator 12.

The extracting step may include supplying the electrical power from the electrical power generator 12 to a nitrogen extraction system 28. The liquifying step may include supplying the electrical power from the electrical power generator 12 to a nitrogen liquefaction system 27.

The above disclosure also provides to the art an electrical power generation system 10 comprising: a power control system 16, a battery bank 14 electrically connected to the power control system and adapted to be charged by electrical power generated by an electrical power generator 12, and a nitrogen extraction system 28 electrically connected to the power control system and adapted to be powered by the electrical power generated by the electrical power generator. The power control system 16 controls delivery of the electrical power from the battery bank 14 to an electrical power grid (such as, a national, state, municipal or local power grid).

Although various examples have been described above, with each example having certain features, it should be understood that it is not necessary for a particular feature of one example to be used exclusively with that example. Instead, any of the features described above and/or depicted in the drawings can be combined with any of the examples, in addition to or in substitution for any of the other features of those examples. One example's features are not mutually exclusive to another example's features. Instead, the scope of this disclosure encompasses any combination of any of the features.

Although each example described above includes a certain combination of features, it should be understood that it is not necessary for all features of an example to be used. Instead, any of the features described above can be used, without any other particular feature or features also being used.

The terms “including,” “includes,” “comprising,” “comprises,” and similar terms are used in a non-limiting sense in this specification. For example, if a system, method, apparatus, device, etc., is described as “including” a certain feature or element, the system, method, apparatus, device, etc., can include that feature or element, and can also include other features or elements. Similarly, the term “comprises” is considered to mean “comprises, but is not limited to.”

Of course, a person skilled in the art would, upon a careful consideration of the above description of representative embodiments of the disclosure, readily appreciate that many modifications, additions, substitutions, deletions, and other changes may be made to the specific embodiments, and such changes are contemplated by the principles of this disclosure. For example, structures disclosed as being separately formed can, in other examples, be integrally formed and vice versa. Accordingly, the foregoing detailed description is to be clearly understood as being given by way of illustration and example only, the spirit and scope of the invention being limited solely by the appended claims and their equivalents.

What is claimed is:

1. An electrical power generation system for use with an electrical power generator, the electrical power generation system comprising:
a battery bank adapted to be charged by electrical power generated by the electrical power generator; and
a nitrogen extraction system adapted to be powered by the electrical power generated by the electrical power generator.

2. The electrical power generation system of claim 1, in which the nitrogen is extracted at a location proximate the battery bank.

3. The electrical power generation system of claim 1, further comprising a valve that selectively permits and prevents flow of the nitrogen in liquid form between a nitrogen source and a housing containing the battery bank.

4. The electrical power generation system of claim 3, in which a valve controller selectively operates the valve based on an output of a thermal sensor that senses a temperature of the battery bank.

5. The electrical power generation system of claim 4, in which the valve controller causes the valve to open when the temperature of the battery bank is greater than a first predetermined level.

6. The electrical power generation system of claim 5, in which the valve controller causes the valve to close when the temperature of the battery bank is less than a second predetermined level.

7. The electrical power generation system of claim 1, in which the electrical power generator comprises at least one of the group consisting of a windmill, a solar cell and a renewable electrical power generator, and
in which the electrical power generated by the electrical power generator is stored locally in the battery bank.

8. An electrical power generation method for use with an electrical power generator, the method comprising:
storing electrical power generated by the electrical power generator in a battery bank located at a battery bank site;
extracting nitrogen at the battery bank site; and
liquifying the nitrogen at the battery bank site.

9. The electrical power generation method of claim 8, further comprising flowing the nitrogen into a housing containing the battery bank in response to a temperature of the battery bank exceeding a first predetermined level.

10. The electrical power generation method of claim 9, further comprising ceasing the nitrogen flow into the housing in response to the temperature of the battery bank being less than a second predetermined level.

11. The electrical power generation method of claim 9, in which the flowing further comprises opening a valve connected between the housing and a source of the nitrogen in liquid form.

12. The electrical power generation method of claim 11, in which operation of the valve is controlled by a valve controller connected to a thermal sensor in the housing.

13. The electrical power generation method of claim 12, in which the valve and the valve controller are powered by the electrical power generated by the electrical power generator.

14. The electrical power generation method of claim 8, in which the extracting comprises supplying the electrical power from the electrical power generator to a nitrogen extraction system, and in which the liquifying comprises supplying the electrical power from the electrical power generator to a nitrogen liquefaction system.

15. An electrical power generation system for use with an electrical power generator, the electrical power generation system comprising:
a power control system;
a battery bank electrically connected to the power control system and adapted to be charged by electrical power generated by the electrical power generator; and
a nitrogen extraction system electrically connected to the power control system and adapted to be powered by the electrical power generated by the electrical power generator,
in which the power control system controls delivery of the electrical power from the battery bank to an electrical power grid.

16. The electrical power generation system of claim 15, in which the nitrogen is extracted at a location proximate the battery bank.

17. The electrical power generation system of claim 15, further comprising a valve that selectively permits and prevents flow of the nitrogen in liquid form between a nitrogen source and a housing containing the battery bank.

18. The electrical power generation system of claim 17, in which a valve controller selectively operates the valve based on an output of a thermal sensor that senses a temperature of the battery bank.

19. The electrical power generation system of claim 18, in which the valve controller causes the valve to open when the temperature of the battery bank is greater than a first predetermined level.

20. The electrical power generation system of claim 19, in which the valve controller causes the valve to close when the temperature of the battery bank is less than a second predetermined level.
